(19) United States
(12) Patent Application Publication
(10) Pub. No.: US 2026/0017772 A1
(43) Pub. Date: Jan. 15, 2026

(54) LEARNING METHOD OF ARTIFICIAL INTELLIGENCE MODEL AND SERVER PERFORMING THE SAME

(71) Applicant: SAMSUNG DISPLAY CO., LTD., YONGIN-SI (KR)

(72) Inventor: Jun Ho JANG, Yongin-si (KR)

(21) Appl. No.: 19/189,652

(22) Filed: Apr. 25, 2025

(30) Foreign Application Priority Data
Jul. 9, 2024 (KR) 10-2024-0090734

(51) Int. Cl. G06T 7/00; G06V 10/764; G06V 10/774; G06V 10/82

(52) U.S. Cl. CPC G06T 7/0004; G06V 10/764; G06V 10/774; G06V 10/82; G06T 2207/20081; G06T 2207/20084; G06T 2207/30108

(57) ABSTRACT

In a learning method of an artificial intelligence model for inspecting a display panel, the learning method includes training a first artificial intelligence model using good quality images of the display panel, and training a second artificial intelligence model including at least a partial layer of the first artificial intelligence model to learn, using bad quality images, different than the good quality images. At least one of the bad quality images is a synthetic image in which a target portion is combined with a base image.

### CROSS-REFERENCE TO RELATED APPLICATION

This application claims priority under 35 U.S.C. § 119 (a) to Korean Patent Application No. 10-2024-0090734, filed on Jul. 9, 2024, in the Korean Intellectual Property Office, the disclosure of which is incorporated by reference herein in its entirety.

### BACKGROUND

### Technical Field

The present disclosure generally relates to a learning method of an artificial intelligence model and a server performing the same, and more particularly, to a learning method of an artificial intelligence model for inspecting a display panel and a server performing the learning method.

### Discussion of Related Art

Display devices have experienced growth and advancement with the rise of information technology. The display device provides a connection medium between a user and information. The display devices may be use any of a variety of technologies, and may be embodied as, for example, a liquid crystal display device, an organic light emitting display device, or an inorganic light emitting display device.

A display device may include a display panel, which may display an image. The display panel may be inspected during or after manufacture to determine whether a defect has occurred in the display panel. The inspection may be performed through an image obtained by photographing an appearance of the display panel. An artificial intelligence model may be used to detect the defect. The artificial intelligence model may receive the image as input and may output a determination about whether the defect has occurred.

### SUMMARY

Embodiments provide a learning method of an artificial intelligence model using a bad quality image generated using a good quality image.

Embodiments also provide a server performing the learning method of the artificial intelligence system.

In accordance with an aspect of the present disclosure, there is provided a learning method of an artificial intelligence model for inspecting a device, the learning method including: training a first artificial intelligence model using good quality images of one or more display panels; and training a second artificial intelligence model including at least a partial layer of the first artificial intelligence model to learn, using bad quality images of the one or more display panels, different than the good quality images, wherein at least one of the bad quality images is a synthetic image in which a target portion is combined with a base image.

The good quality images may be sorted into a plurality of classes. The training of the first artificial intelligence model may include: extracting feature vectors of the good quality images through the first artificial intelligence model; and training the first artificial intelligence model such that the classes of the good quality images are sorted by the first artificial intelligence model based on the feature vectors of the good quality images.

The training of the first artificial intelligence model based on feature vectors of the good quality images may include: predicting the classes of the good quality images, based on the feature vectors of the good quality images through the first artificial intelligence model; calculating a loss, based on prediction values of the classes; and training the first artificial intelligence model such that the loss satisfies a loss threshold value.

The loss may be calculated through a cross-entropy loss function.

The second artificial intelligence model may include a first layer and a second layer, which extract the feature vectors of the good quality images of the first artificial intelligence model. The training of the second artificial intelligence model may include: extracting the feature vectors of the good quality images and feature vectors of the bad quality images through the first layer; training the first layer to learn such that a distance between the feature vectors of the good quality images and the feature vectors of the bad quality images is greater than or equal to a predetermined reference distance; and training the second layer to learn such that the feature vectors of the good quality images and the feature vectors of the bad quality images are sorted.

The second layer may be a binary fully connected layer.

The classes may correspond to positions in the display panel, and wherein the base image is selected from the good quality images or is another good quality image.

The good quality images may be sorted into a plurality classes. The training of the second artificial intelligence model to learn may include: extracting feature vectors of the good quality images through the first artificial intelligence model; generating a probability distribution of each of the classes by inputting the feature vectors of the good quality images to a Gaussian Mixture Model (GMM); calculating a loss, based on the probability distribution of each of the classes; and training the first artificial intelligence model to learn such that the loss satisfies a loss threshold value.

The loss may be calculated through a loss function obtained by using the probability distribution of each of the classes in the cross-entropy loss function.

The second artificial intelligence model may include a first layer and a second layer of the first artificial intelligence model. The training of the second artificial intelligence model may include: extracting the feature vectors of the good quality images and feature vectors of the bad quality images through the first layer; training the first layer to learn such that a distance between the feature vectors of the good quality images and the feature vectors of the bad quality images is greater than or equal to a predetermined reference distance; and training the second layer such that the feature vectors of the good quality images and the feature vectors of the bad quality images are sorted.

In accordance with another aspect of the present disclosure, there is provided an artificial intelligence system executed by a server for inspecting a device, the server including: a storage medium configured to store a first artificial intelligence model; and a processor configured to train the first artificial intelligence model using good quality images of one or more display panels, generate a second artificial intelligence model including at least a partial layer of the first artificial intelligence model, and train the second artificial intelligence model using bad quality images of the one or more display panels, different than the good quality images, wherein at least one of the bad quality images is a synthetic image in which a target portion is combined with a base image.

The good quality images may be sorted into a plurality of classes. The processor may extract feature vectors of the good quality images through the first artificial intelligence model, and train the first artificial intelligence model such that the classes of the good quality images are sorted by the first artificial intelligence model based on the feature vectors of the good quality images.

The processor may predict the classes of the good quality images, based on the feature vectors of the good quality images through the first artificial intelligence model, calculate a loss, based on prediction values of the classes, and train the first artificial intelligence model to learn such that the loss satisfies a loss threshold value.

The loss may be calculated through a cross-entropy loss function.

The second artificial intelligence model may include a first layer and a second layer, which extract the feature vectors of the good quality images of the first artificial intelligence model. The processor may extract the feature vectors of the good quality images and feature vectors of the bad quality images through the first layer, train the first layer such that a distance between the feature vectors of the good quality images and the feature vectors of the bad quality images is greater than or equal to a predetermined reference distance, and train the second layer such that the feature vectors of the good quality images and the feature vectors of the bad quality images are sorted.

The second layer may be a binary fully connected layer.

The classes may correspond to positions in the display panel, and wherein the base image is selected from the good quality images or is another good quality image.

The good quality images may be sorted into a plurality classes. The processor may extract feature vectors of the good quality images through the first artificial intelligence model, generate a probability distribution of each of the classes by inputting the feature vectors of the good quality images to a Gaussian Mixture Model (GMM), calculate a loss, based on the probability distribution of each of the classes, and train the first artificial intelligence model to learn such that the loss satisfies a loss threshold value.

The loss may be calculated through a loss function obtained by using the probability distribution of each of the classes in the cross-entropy loss function.

The second artificial intelligence model may include a first layer and a second layer of the first artificial intelligence model. The processor may extract feature vectors of the good quality images and feature vectors of the bad quality images through the first layer, train the first layer to learn such that a distance between the feature vectors of the good quality images and the feature vectors of the bad quality images is greater than or equal to a predetermined reference distance, and train the second layer to learn such that the feature vectors of the good quality images and the feature vectors of the bad quality images are sorted.

In accordance with another aspect of the present disclosure, there is provided a learning method of an artificial intelligence system for inspecting a device, the learning method including receiving first data including good quality images of one or more display panels, preparing second data by marking the good quality image to generate bad quality images of the one or more display panels, training a first artificial intelligence model using good quality images of one or more display panels, and training a second artificial intelligence model including at least a partial layer of the first artificial intelligence model using bad quality images of the one or more display panels, different than the good quality images.

The good quality images are sorted into a plurality of classes, and the training of the first artificial intelligence model may include extracting feature vectors of the good quality images through the first artificial intelligence model, and training the first artificial intelligence model such that the classes of the good quality images are sorted by the first artificial intelligence model based on the feature vectors of the good quality images.

The second artificial intelligence model may include a first layer and a second layer of the first artificial intelligence model and the training of the second artificial intelligence model may include extracting feature vectors of the good quality images and feature vectors of the bad quality images through the first layer, training the first layer such that a distance between the feature vectors of the good quality images and the feature vectors of the bad quality images is greater than or equal to a predetermined reference distance, and training the second layer such that the feature vectors of the good quality images and the feature vectors of the bad quality images are sorted.

### BRIEF DESCRIPTION OF THE DRAWINGS

Illustrative, non-limiting embodiments will be more clearly understood from the following detailed description in conjunction with the accompanying drawings.

FIG. 1 is a flowchart illustrating a learning method of an artificial intelligence model in accordance with embodiments of the present disclosure.

FIG. 2 is a block diagram illustrating an example of a server performing the learning method shown in FIG. 1.

FIG. 3 is a view illustrating classes, and FIG. 4 is a view illustrating an example of a good quality image of a first class.

FIG. 5 is a view illustrating an example of a bad quality image of the first class.

FIG. 6 is a view illustrating another example of the bad quality image of the first class.

FIG. 7 is a flowchart illustrating an example of S100 shown in FIG. 1.

FIG. 8 is a view illustrating an example of a first artificial intelligence model shown in FIG. 2.

FIG. 9 is a flowchart illustrating another example of S100 shown in FIG. 1.

FIG. 10 is a view illustrating another example of the first artificial intelligence model shown in FIG. 2.

FIG. 11 is a flowchart illustrating an example of S200 shown in FIG. 1.

FIG. 12 is a view illustrating an example of an artificial intelligence model shown in FIG. 2.

### DETAILED DESCRIPTION

Hereinafter, embodiments of the present disclosure will be described in more detail with reference to the accompanying drawings; however, embodiments may be embodied in different forms and should not be construed as limited by the present disclosure. Rather, embodiments are provided so that the disclosure will be thorough and complete, and will fully convey the scope of the disclosure to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

In the description below, only parts needed to understand an operation according to the present disclosure may be described and the descriptions of other parts may be omitted in order not to unnecessarily obscure subject matter of the present disclosure. In addition, the present disclosure is not limited to exemplary embodiments described herein, but may be embodied in various different forms. Rather, exemplary embodiments described herein are provided to thoroughly and completely describe the disclosed contents and to sufficiently convey the ideas of the disclosure to a person of ordinary skill in the art.

In the entire specification, when an element is referred to as being “connected” or “coupled” to another element, it can be directly connected or coupled to the another element or be indirectly connected or coupled to the another element with one or more intervening elements interposed therebetween. The technical terms used herein are used only for the purpose of illustrating embodiments and are not intended to limit embodiments. It will be understood that when a component “includes” an element, unless there is another opposite description thereto, it should be understood that the component does not exclude another element but may further include another element. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Similarly, for the purposes of this disclosure, “at least one selected from the group consisting of X, Y, and Z” can be construed as X only, Y only, Z only, or any combination of two or more items X, Y, and Z (e.g., XYZ, XYY, YZ, ZZ).

It will be understood that, although the terms “first”, “second,” etc. may be used herein to describe various elements, these elements should not be limited by these terms. These terms are only used to distinguish one element from another element. Thus, a “first” element discussed below could also be termed a “second” element without departing from the teachings of the present disclosure.

Spatially relative terms, such as “below,” “above,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

In addition, embodiments of the disclosure are described here with reference to schematic diagrams of certain aspects (and an intermediate structure) of the present disclosure, so that changes in a shape as shown due to, for example, manufacturing technology and/or a tolerance may be expected. Therefore, embodiments of the present disclosure shall not be limited to the specific shapes of a region shown here, but include shape deviations caused by, for example, the manufacturing technology. The regions shown in the drawings are schematic in nature, and the shapes thereof may not represent the actual shapes of the regions of the device, and do not limit the scope of the disclosure.

Hereinafter, exemplary embodiments of the present disclosure will be described in detail with reference to the accompanying drawings.

In an embodiment, an artificial intelligence system may be trained using multiple artificial intelligence models and a plurality of images that include good quality images GV and bad quality images BV. The artificial intelligence system may be implemented to detect defects in a target, such as a display panel.

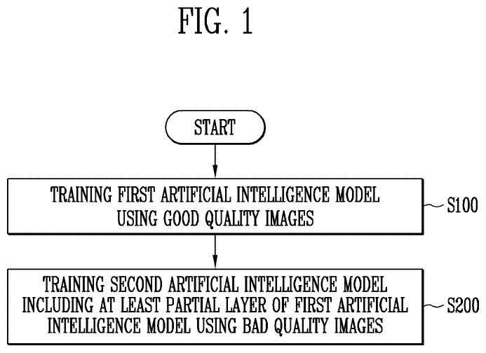

FIG. 1 is a flowchart illustrating a learning method of an artificial intelligence model in accordance with embodiments of the present disclosure.

Referring to FIG. 1, in a learning method, a first artificial intelligence model and a second artificial intelligence model may be provided. The first artificial intelligence model may be trained on prepared first input. The first artificial intelligence model may be trained on first input including good quality images (S100). The second artificial intelligence model, including at least a partial layer of the first artificial intelligence model may be trained on prepared second input. The second artificial intelligence model may be trained on second input include bad quality images (S200).

The second artificial intelligence model may be a model trained for inspecting a display panel of a display device. The second artificial intelligence model may receive an image obtained by photographing the display panel. The image may be a portion of the first input and a portion of second input. The image may be selected for its quality and modified to include the second input. For example, the second input may capture an example of a specific defect in a display panel to be trained by the second artificial intelligence model. The second artificial intelligence model may process an image of a display panel including a first input portion and a second input portion, and may output a decision about whether a defect has been perceived in the image of the display panel.

The first artificial intelligence model and the second artificial intelligence model may include a plurality of artificial neural network layers. The artificial neural network layer may be one of a deep neural network (DNN), a convolutional neural network (CNN), a recurrent neural network (RNN), a restricted boltzman machine (RBM), a deep belief network (DBN), a bidirectional recurrent deep neural network (BRDNN), or a deep Q-network, or any combination of two or more thereof, but the present disclosure is not necessarily limited to examples described herein.

The first artificial intelligence model, trained on the first input, and the second artificial intelligence model, trained on the second input, may be used together. The first artificial intelligence model and the second artificial intelligence model may be trained to process a new image of a display panel and output a decision about whether a defect has been perceived in the image of the display panel. The second artificial intelligence model may be modified to include at least a partial layer of the first artificial intelligence model trained using the first input.

The modification of the second artificial intelligence model may be performed by model merging, such as model souping. For example, the second artificial intelligence model may be modified to include a layer of the first artificial intelligence model without further training. In another example, the second artificial intelligence model may be modified to include a weight level of the layer of the first artificial intelligence model or partial layer of the first artificial intelligence model without further training. The weight level may include using magnitudes and directions for deltas between nodes of layers. For example, a capability of characterizing good quality images of the first artificial intelligence model, encoded by the partial layer of the first artificial intelligence model, may be transferred to the second artificial intelligence model, which may be trained on bad quality images.

In an embodiment, the modification of the second artificial intelligence model may be performed by model merging, but the present disclosure is not necessarily limited to examples described herein. For example, the first artificial intelligence model, trained on the first input, and the second artificial intelligence model, trained on the second input, may be implemented as consulting artificial intelligence models or as divide and conquer artificial intelligence models, to combine the capabilities of the first artificial intelligence model and the second artificial intelligence model.

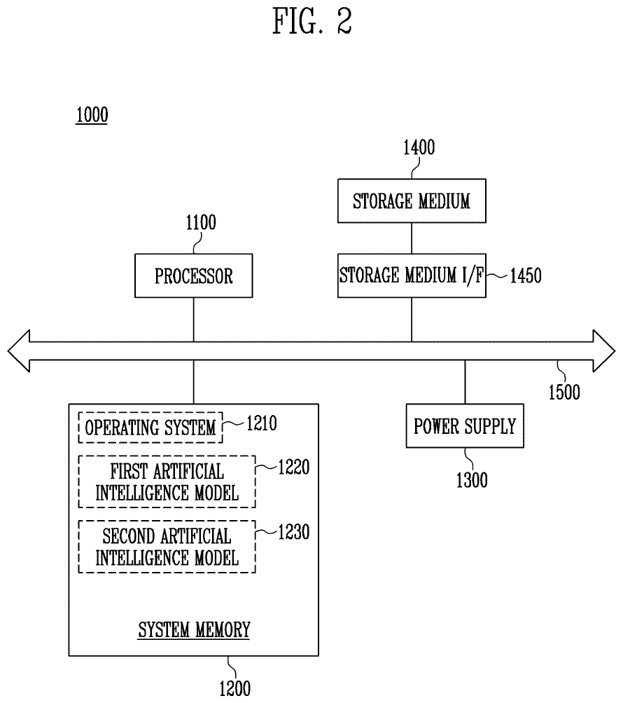

FIG. 2 is a block diagram illustrating an example of a server performing a learning method shown in FIG. 1. A processor 1100 shown in FIG. 2 may perform S100 and S200, which are shown in FIG. 1.

Referring to FIG. 2, a server 1000 may include the processor 1100, a system memory 1200, a power supply 1300, a storage medium 1400, a storage medium interface (I/F) 1450, and a bus 1500.

The processor 1100 may include one or more of a general purpose or a dedicated processor. For example, the processor 1100 may be a Graphical Processing Unit (GPU), a Tensor Processing Unit (TPU), or an artificial intelligence (AI) accelerator. The processor 1100 may control an overall operation of the server 1000. The processor 1100 may be configured to load, to the system memory 1200, program codes and commands, which may be executed to provide various functions, and process the loaded program codes and the load commands.

The system memory 1200 may be provided as a working memory and/or a buffer memory of the processor 1100. In an embodiment, the system memory 1200 may include at least one among a Random Access Memory (RAM), a Read Only Memory (ROM), or a medium readable by another type of computer.

An operating system 1210 may be stored in the system memory 1200.

The processor 1100 may load a first artificial intelligence model 1220 and a second artificial intelligence model 1230 to the system memory 1200. The processor 1100 may generate the second artificial intelligence model 1230, based on the first artificial intelligence model 1220. The second artificial intelligence model 1230 may be stored in the storage medium 1400.

The first artificial intelligence model 1220 and the second artificial intelligence model 1230 may be implemented in a form of hardware, software, or an application-specific integrated circuit (ASIC). For example, the processor 1100 may load the first artificial intelligence model 1220 and the second artificial intelligence model 1230 to the system memory 1200, or load, to the system memory 1200, program codes and/or commands, which may be used to control the first artificial intelligence model 1220 and the second artificial intelligence model 1230.

The program codes and/or commands may be loaded to the system memory 1200 from the storage medium as a recoding medium readable by the server 1000. Alternatively or in addition, the program codes and/or commands may be loaded to the system memory 1200 from an outside of the server 1000 through a communication device.

The processor 1100 may execute the operating system 1210. For example, the processor 1100 may load, to the system memory 1200, the operating system 1210 for providing an appropriated environment in which the first artificial intelligence model 1220 and the second artificial intelligence model 1230 may be executed, and execute the first artificial intelligence model 1220 and the second artificial intelligence model 1230.

The operating system 1210 may perform interfacing such that the first artificial intelligence model 1220 and the second artificial intelligence model 1230 can use components such as the storage medium interface 1450 of the server 1000.

In some embodiments of the present disclosure, at least one function of the storage medium interface 1450 may be performed by the operating system 1210.

Although it is illustrated that the system memory 1200 may be a component distinguished from the processor 1100, at least a portion of the system memory 1200 may be included in the processor 1100. In some embodiments, the system memory 1200 may be provided as a plurality of memories physically and/or logically separated from each other.

The power supply 1300 may provide a voltage for driving at least one component among the processor 1100, the system memory 1200, the storage medium 1400, or the storage medium interface 1450.

The storage medium 1400 may be configured to store data.

For example, the storage medium 1400 may store the first artificial intelligence model 1220 and the second artificial intelligence model 1230. The storage medium 1400 may include various types of nonvolatile storage media, which may retain stored data even when the supply of power is interrupted. The nonvolatile storage media may include, for example, a nonvolatile memory. The nonvolatile memory may include, for example, a flash memory, a hard disk, and the like.

The storage medium interface 1450 may be connected to the storage medium 1400. The storage medium interface 1450 may interface between the storage medium 1400 and components such as the processor 1100 and the system memory 1200, which may be connected to the bus 1500.

The bus 1500 may be connected to various components of the server 1000, and may be used to transfer one or more of data, signals, or information.

In an embodiment, the server 1000 may include a plurality of computer devices. For example, the computer devices of the server 1000 may be connected to a network online and/or offline.

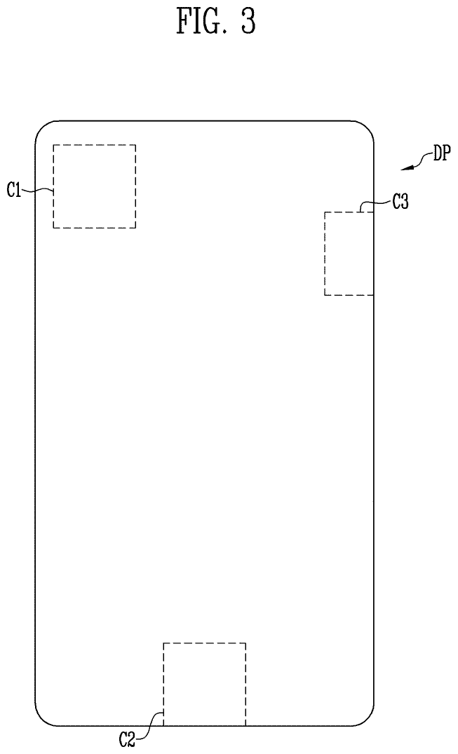

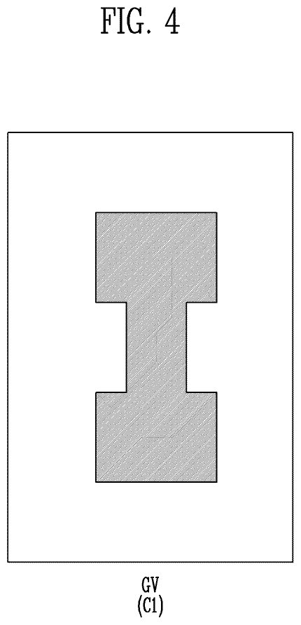

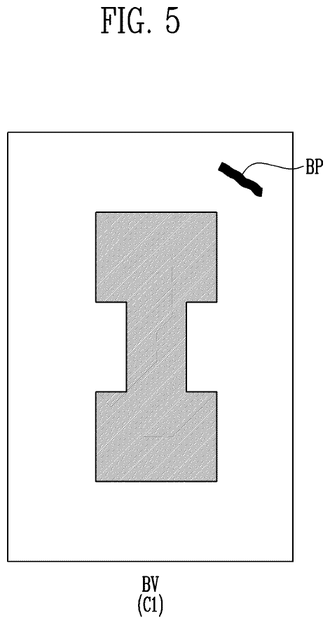

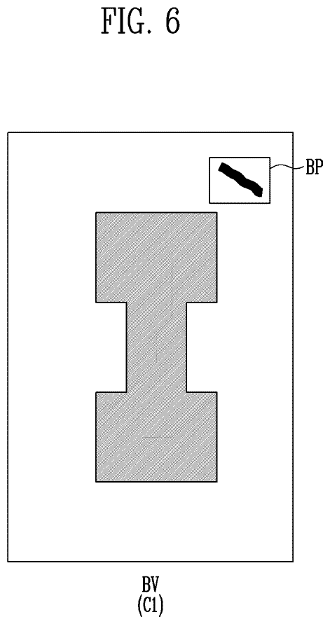

FIG. 3 is a view illustrating classes of image data. FIG. 4 is a view illustrating an example of a good quality image of a first class. FIG. 5 is a view illustrating an example of a bad quality image of the first class. FIG. 6 is a view illustrating another example of the bad quality image of the first class.

For convenience of description, FIG. 4, FIG. 5, and FIG. 6 illustrate only a first class C1, and bad quality images of other classes may be substantially generated using a method as described in connection with FIG. 5 and FIG. 6.

Referring to FIG. 3 and FIG. 4, good quality images GV may be sorted into a plurality of classes (e.g., a first class C1, a second class C2, and third class C3). The classes may correspond to positions in a display panel DP.

For example, a good quality image GV of the first class C1 may be an image at a position (see FIG. 3) corresponding to the first class C1 of the display panel DP, a good quality image GV of the second class C2 may be an image at a position (see FIG. 3) corresponding to the second class C2 of the display panel DP, and a good quality image GV of the third class C3 may be an image at a position (see FIG. 3) corresponding to the third class C3 of the display panel D).

A plurality of good quality images GV may be photographed for each class. Good quality images GV of the same class may be images photographed at different positions on one or more display panels. Good quality images GV of the same class may not be images photographed at exactly the same position, Each class of good quality images GV may include a plurality of images of the same class.

The classes may be photographed using different cameras. However, the present disclosure is not limited thereto, and a good quality image GV may be photographed using the same camera.

Although three classes are exemplified, the present disclosure is not limited to a number of the classes or example positions of the classes. In an embodiment, a class may be sorted by position on the display panel. For example, a class may be sorted into a front position on the display panel, a rear position on the display panel, or a side position on the display panel, or at least one class may be included in each of the front position on the display panel, the rear position on the display panel, and the side position on the display panel.

Referring to FIG. 5 and FIG. 6, a bad quality image may be an image in which a bad quality portion BP is combined with a base image, which may be selected from any of the good quality image GV used to train the first artificial intelligence model or another good quality image GV. The bad quality portion BP may be a target portion added based on experiential information. For example, a bad quality image BV may be an image in which information about a defect of interest may be expressed as image data in a good quality image GV or an image in which a target portion may be synthesized in a good quality image GV. A bad quality image BV including a bad quality portion BP combined with a base image may be referred to as a synthetic image. For example, a defect of interest may be determined by a conventional system, using inspection equipment, and an image of the defect of interest, e.g., a portion of an image, may be added to a good quality image GV to generate a synthetic image, which may be used for training the second artificial intelligence model 1230.

In an embodiment, as shown in FIG. 5, a bad quality image BV may be prepared. The bad quality image BV may be an image in which a mark is directly drawn in the good quality image GV, where a portion of the good quality image GV bearing the mark becomes the bad quality portion BP and the good quality image GV becomes a bad quality image BV. For example, the mark of the bad quality portion BP may be drawn in the good quality image GV using image manipulation software. The bad quality portion BP may be, for example, an image of a scratch on a surface of a display panel, a contaminant that may be visible in a display panel, or broken die disposed in a display panel, such as a microLED display panel.

In an embodiment, as shown in FIG. 6, a bad quality image BV may be an image in which a bad quality portion is pasted into the good quality image GV. The bad quality portion may be a portion electronically copied or cut from another image using image manipulation software.

As such, an image modified to include a bad quality portion may be used for model training of the second artificial intelligence model. For example, a step of identifying a set of new or novel bad quality images having a defect of interest may be omitted in a case where the bad quality images may be generated, and the time needed to collect the bad quality images BV can be saved.

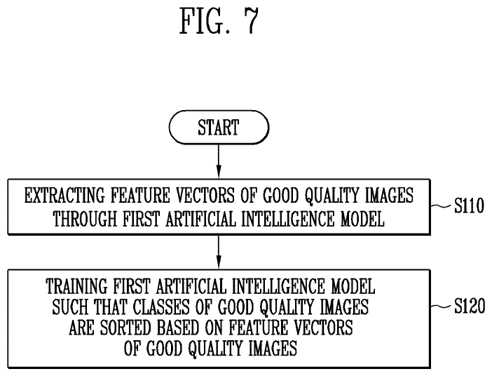

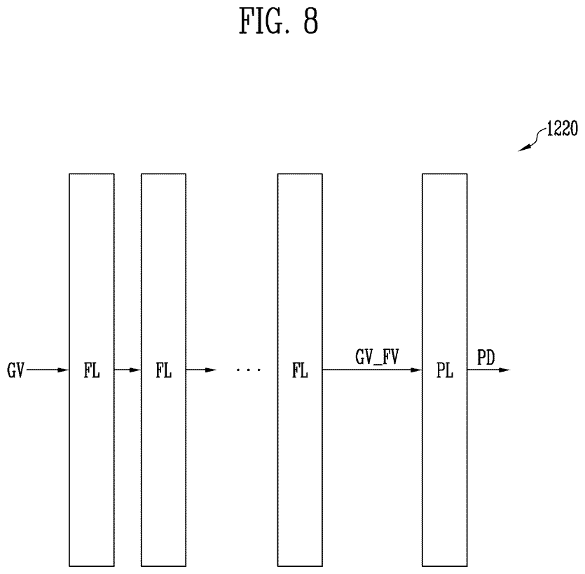

FIG. 7 is a flowchart illustrating an example of S100 shown in FIG. 1. FIG. 8 is a view illustrating an example of the first artificial intelligence model shown in FIG. 2.

Referring to FIG. 3, FIG. 7, and FIG. 8, in a learning method, feature vectors GV_FV of good quality images GV may be extracted using the first artificial intelligence model 1220 (S110). The first artificial intelligence model 1220 may be trained to learn classes (e.g., first to third classes C1 to C3) of the good quality images GV. The good quality images GV may be sorted by class based on the feature vectors GV_FV of the good quality images GV (S120).

The first artificial intelligence model 1220, previously trained, may predict classes of the good quality images GV, based on the feature vectors GV_FV of the good quality images GV. For example, the first artificial intelligence model 1220 may output prediction values PV of the classes.

The first artificial intelligence model 1220 may include feature layers FL and a prediction layer PL. The feature layers FL may receive a good quality image GV and may output a feature vector GV_FV of the good quality image GV. The prediction layer PL may receive the feature vector GV_FV of the good quality image GV and may predict which class the good quality GV corresponds to. For example, the prediction layer PL may receive the feature vector GV_FV of the good quality image GV and may output prediction values PV of the classes. For example, the prediction values PV of the classes may include a probability that the good quality image GV will be included in the first class C1, a probability that the good quality image GV will be included in the second class C2, and a probability that the good quality image GV will be included in the third class C3.

In an embodiment, the prediction layer PL may be configured as one layer. However, the present disclosure is not limited to the number of the prediction layer PL.

The first artificial intelligence model 1220 may be trained and a first loss calculated based on the prediction values PV of the classes may be reduced during training. For example, a weighted value or bias of the feature layers FL may be adjusted to reduce the first loss to a first loss threshold.

The first loss may be calculated through a cross-entropy loss function. For example, the first loss may be calculated through Expression 1 as an example:

$$CE = - {{\sum }_{i}}^{C} {t}_{i} log ( {f ( s )}_{i} ) \qquad Expression 1$$

In Expression 1, CE is the first loss, C is a class, tᵢ is a probability of a class corresponding to an actual class, s is a good quality image GV input to the first artificial intelligence model 1220, and f(s)ᵢ is a prediction value PV of class i of the good quality image GV. A probability of the and class i corresponding to the actual class may have a value of 1 when the actual class and the class I are the same, and have a value of 0 when the actual class and the class/are not the same. For example, tᵢ of the good quality image of the first class C1 may be [1, 0, 0].

A loss value may be a summation of the errors made by the model for each example in a training set. For example, when a good quality image GV of the first class C1 is input, and the first artificial intelligence model 1220 predicts, as 0.7, a probability that the good quality image GV will belong to the first class C1, predicts, as 0.2, a probability that the good quality image GV will belong to the second class C2, and predicts, as 0.1, a probability that the good quality image GV will belong to the third class C3, the first loss may be determined as −(1*log(0.7)+0*log(0.2)+0*log(0.1)).

Accordingly, the first artificial intelligence model 1220 can have improved performance of sorting classes and have improved performance in which the feature layers FL extracts the feature vectors GV_FV of the good quality images GV, such that the classes may be accurately sorted.

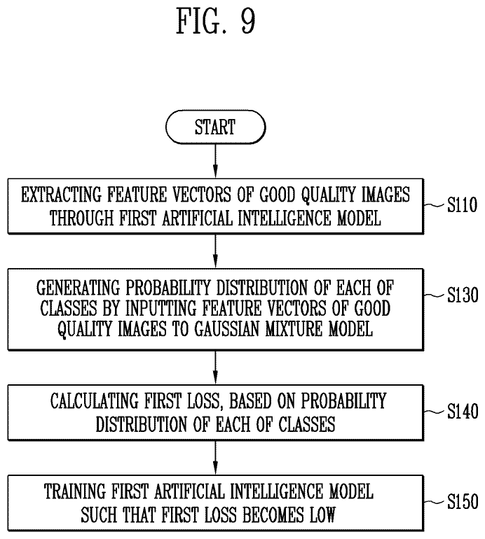

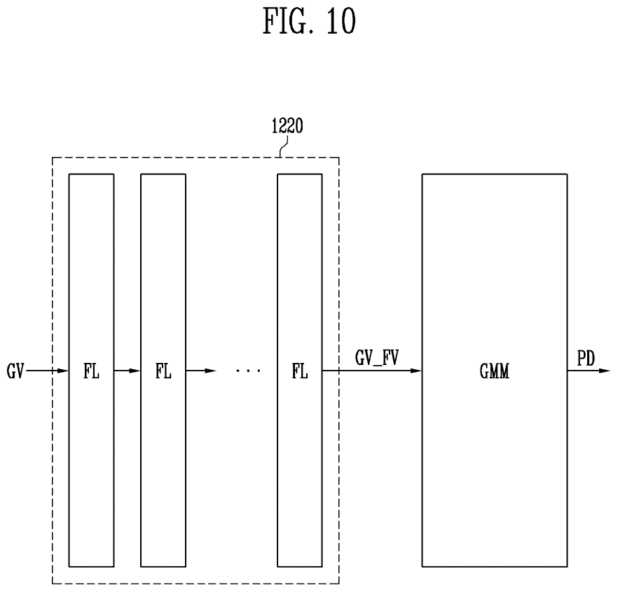

FIG. 9 is a flowchart illustrating another example of S100 shown in FIG. 1. FIG. 10 is a view illustrating another example of the first artificial intelligence model shown in FIG. 2.

Referring to FIG. 3, FIG. 9, and FIG. 10, in a learning method, feature vectors GV_FV of good quality images GV may be extracted through the first artificial intelligence model 1220 (S110), a probability distribution PD of each class (e.g., first to third classes C1 to C3) may be generated by inputting the feature vectors GV_FV of the good quality images GV to a Gaussian Mixture Model (GMM) (S130), a first loss may be calculated based the probability distribution PD of each of the classes (S140), and the first artificial intelligence model 1220 may be trained until the first loss becomes low (S150). The low first loss may be a threshold value used in training the first artificial intelligence model 1220. For example, the first artificial intelligence model 1220 may be trained until the first loss of the first artificial intelligence model 1220 satisfies a first loss threshold value. For example, the first artificial intelligence model 1220 may be trained until the first loss of the first artificial intelligence model 1220 is equal to or less than the first loss threshold value.

The first artificial intelligence model 1220 may include a plurality of feature layers FL. The feature layers FL may receive a good quality image GV and may output a feature vector GV_FV of the good quality image GV.

The GMM may receive feature vectors GV_FV of good quality images of each class and may output a probability distribution PD of each class. For example, the probability distribution PD of each class may have a form in which a plurality of Gaussian distributions may be combined. For example, each class may have its own probability distribution PD. For example, the probability distribution of each class may be calculated through Expression 2, for example.

$$\hat{p} ( y \vert x ) = {{\sum }^{K}}_{k = 1} {w}_{k} ( x ; θ ) 𝒩 ( y \vert {μ}_{k} ( x ; θ ) , {σ}_{k}^{2} ( x ; θ ) ) \qquad Expression 2$$

In Expression 2, p(ŷ|x) is a probability distribution PD of each class, x is a good quality image GV, K is a number of Gaussian distributions, which is a predetermined value, wₖ(x; θ) is a weighted value of a k^{th} Gaussian distribution,

$$𝒩 ( y \vert {μ}_{k} ( x ; θ ) , {σ}_{k}^{2} ( x ; θ ) )$$

is the k^{th} Gaussian distribution, and θ is a parameter of the GMM.

The first artificial intelligence model 1220 may be trained such that the first loss calculated based on the probability distribution PD of each class becomes low. For example, a weighted value or bias of the feature layers FL may be adjusted such that the first loss becomes low. For example, the first artificial intelligence model 1220 may be trained until the first loss of the first artificial intelligence model 1220 is at or less than the first loss threshold value.

The first loss may be calculated through a loss function obtained by replacing an entropy portion with the probability distribution PD of each class in the cross-entropy loss function, for example, using the Expression 1.

For example, in the loss function, the probability distribution PD of each class may be used, instead of f(s)ᵢ as in Expression 1. A probability distribution PD generated based on a plurality of good quality images GV may be used, and therefore, tᵢ may be a ratio of each class among the good quality images GV.

For example, when a ratio of the first class C1 among all the good quality images GV is 0.7, a ratio of the second class C2 among all the good quality images GV is 0.2, and a ratio of the third class C32 among all the good quality images GV is 0.1, tᵢ may be [0.7, 0.2, 0.1].

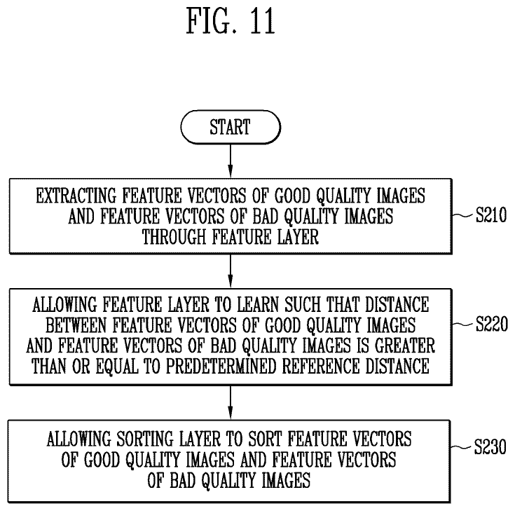

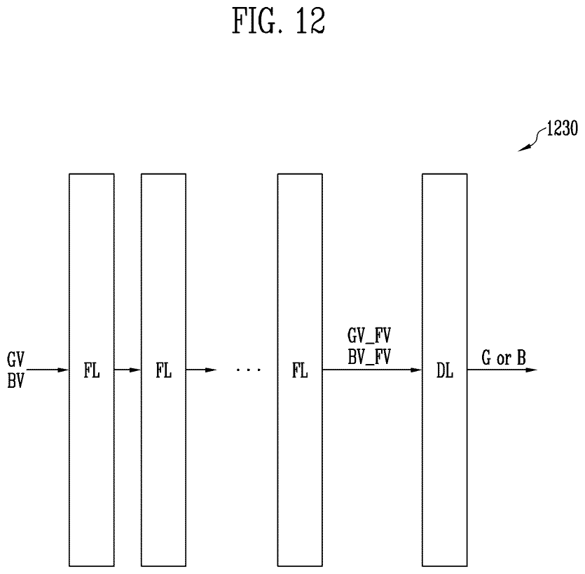

FIG. 11 is a flowchart illustrating an example of S200 shown in FIG. 1. FIG. 12 is a view illustrating an example of the second artificial intelligence model shown in FIG. 2.

Referring to FIG. 11 and FIG. 12, in a learning method, feature vectors GV_FV of good quality images GV and feature vectors BV_FV of bad quality images BV may be extracted through a feature layer (S210). The feature layer(s) FL may be trained such that a distance between the feature vectors GV_FV of the good quality images GV and the feature vectors BV FV of the bad quality images BV is greater than or equal to a predetermined reference distance (S220). A sorting layer DL may be trained such that input feature vectors, e.g., the feature vectors GV_FV of the good quality images GV and the feature vectors BV_FV of the bad quality images BV, may be sorted from each other (S230).

The second artificial intelligence model 1230 may include feature layers FL and the sorting layer DL. The feature layers FL of the second artificial intelligence model 1230 may extract feature vectors GV_FV of good quality images GV and extract feature vectors BV FV of bad quality images BV. The sorting layer DL may output data G indicating whether the input feature vector is a feature vector of the good quality image GV or may output data B indicating that the input feature vector is a feature vector of the bad quality image BV. For example, as shown in FIG. 8, the first artificial intelligence model 1220 may include a plurality of feature layers FL and a prediction layer PL. The second artificial intelligence model 1230 may be generated by removing the prediction layer PL from the first artificial intelligence model 1220 and adding the sorting layer DL. For example, as shown in FIG. 10 and FIG. 12, while the first artificial intelligence model 1220 may include only the feature layers FL, the second artificial intelligence model 1230 may be generated by adding the sorting layer DL to the first artificial intelligence model 1220.

The feature layers FL of the second artificial intelligence model 1230 may receive a good quality image GV and a bad quality image BV and may output a feature vector GV_FV of the good quality image GV and a feature vector BV_FV of the bad quality image BV. The feature layers FL of the second artificial intelligence model 1230 may be trained such that a distance between the feature vector GV_FV of the good quality image GV and the feature vector BV FV of the bad quality image BV is greater than or equal to a predetermined reference distance.

In an embodiment, the feature layers FL may be trained such that a second loss calculated based on the feature vector GV_FV of the good quality image GV and/or the feature vector BV_FV of the bad quality image BV becomes low. For example, a weighted value or a bias of the feature layers FL may be adjusted such that the second loss becomes low. For example, the weighted value or the bias of the feature layers FL may be adjusted such that the second loss is at or less than a second loss threshold value.

The second loss may be calculated through Expression 3, for example.

$$L ( {x}_{i} , {x}_{j} ) = 1 [ {y}_{i} = {y}_{j} ] ‖ f ( {x}_{i} ) - f ( {x}_{j} ) {\vert \vert}_{2}^{2} + 1 [ {y}_{i} \neq {y}_{j} ] max ( 0 , R = {‖ f ( {x}_{i} ) - f ( {x}_{j} ) ‖}_{2}^{2} ) \qquad Expression 3$$

In Expression 3, L(xᵢ,xⱼ) is the second loss, xᵢ is an i^{th} image, xⱼ is a j^{th} image, 1[yᵢ=yⱼ] has a value of 1 when the i^{th} image and the j^{th} image are of the same kind (e.g., when both are good quality images GV or both are bad quality images BV) and has a value of 0 when the i^{th} image and the j^{th} image are of different kinds (e.g., when any one of the i^{th} image and the j^{th} image is a good quality image GV and the other of the i^{th} image and the j^{th} image is a bad quality image BV), f(xᵢ) is a feature vector of the i^{th} image, f(xⱼ) is a feature vector of the j^{th} image, 1[yᵢ‥yⱼ] has the value of 0 when the i^{th} image and the j^{th} image are of the same kind (e.g., when both are good quality images GV or both are bad quality images BV) and has the value of 1 when the i^{th} image and the j^{th} image are of different kinds (e.g., when any one of the i^{th} image and the j^{th} image is a good quality image GV and the other of the i^{th} image and the j^{th} image is a bad quality image BV), and R is the reference distance.

Accordingly, a distance between good quality images GV (e.g., a distance between feature vectors GV_FV of the good quality images GV) may be reduced, a distance between bad quality images BV (e.g., a distance between feature vectors BV_FV of the bad quality images BV) may be reduced, and a distance between the good quality images GV and the bad quality images BV (e.g., a distance between the feature vectors GV_FV of the good quality images GV and the feature vectors BV_FV of the bad quality images BV) may be increased. That is, each of the good quality images GV and the bad quality images BV may form a cluster.

The sorting layer DL may be trained to sort the feature vectors GV_FV of the good quality images GV and the feature vectors BV FV of the bad quality images BV. For example, when a specific feature vector is input, the sorting layer DL may determine whether the specific feature vector is a feature vector GV_FV of a good quality image GV or a feature vector BV_FV of a bad quality image BV. For example, the sorting layer DL may output data G indicating that the input feature vector is the feature vector of the good quality image GV or data B indicating that the input feature vector is the feature vector of the bad quality image BV. While the sorting layer DL is trained, the feature layers FL may be frozen.

For example, the sorting layer DL may be a binary fully connected layer. However, aspects of the present disclosure are not limited thereto, and the sorting layer DL may be a layer capable of sorting two or more groups.

In a learning method of the second artificial intelligence model in accordance with the present disclosure, bad quality images may be used, so that inspection accuracy can be improved as compared with an artificial intelligence model trained using only good quality images.

In a learning method of the second artificial intelligence model in accordance with the present disclosure, a worker directly uses bad quality images in which frequently occurring defects are displayed in good quality image, and excessive inspection or erroneous inspection of defects can be reduced, and the time required to collect bad quality images can be saved.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A learning method of an artificial intelligence system for inspecting a device, the learning method comprising:
training a first artificial intelligence model using good quality images of one or more display panels; and
training a second artificial intelligence model including at least a partial layer of the first artificial intelligence model using bad quality images of the one or more display panels, different than the good quality images.

2. The learning method of claim 1, wherein the good quality images are sorted into a plurality of classes, and
wherein the training of the first artificial intelligence model includes:
extracting feature vectors of the good quality images through the first artificial intelligence model; and
training the first artificial intelligence model such that the classes of the good quality images are sorted by the first artificial intelligence model based on the feature vectors of the good quality images.

3. The learning method of claim 2, wherein the training of the first artificial intelligence model based on the feature vectors of the good quality images, includes:
predicting the classes of the good quality images, based on the feature vectors of the good quality images through the first artificial intelligence model;
calculating a loss, based on prediction values of the classes; and
training the first artificial intelligence model such that the loss satisfies a loss threshold value.

4. The learning method of claim 3, wherein the loss is calculated through a cross-entropy loss function.

5. The learning method of claim 3, wherein the second artificial intelligence model includes a first layer and a second layer, and
wherein the training of the second artificial intelligence model to learn includes:
extracting the feature vectors of the good quality images and feature vectors of the bad quality images through the first layer;
training the first layer to learn such that a distance between the feature vectors of the good quality images and the feature vectors of the bad quality images is greater than or equal to a predetermined reference distance; and
training the second layer to learn such that the feature vectors of the good quality images and the feature vectors of the bad quality images are sorted.

6. The learning method of claim 5, wherein the second layer is a binary fully connected layer.

7. The learning method of claim 2, wherein the classes correspond to positions in the display panel,
wherein at least one of the bad quality images is a synthetic image in which a target portion is combined with a base image, and
wherein the base image is selected from the good quality images or is another good quality image.

8. The learning method of claim 1, wherein the good quality images are sorted into a plurality classes, and
wherein the training of the second artificial intelligence model includes:
extracting feature vectors of the good quality images through the first artificial intelligence model;
generating a probability distribution of each of the classes by inputting the feature vectors of the good quality images to a Gaussian Mixture Model (GMM);
calculating a loss, based on the probability distribution of each of the classes; and
training the first artificial intelligence model such that the loss satisfies a loss threshold value.

9. The learning method of claim 8, wherein the loss is calculated through a loss function using the probability distribution of each of the classes in a cross-entropy loss function.

10. The learning method of claim 1, wherein the second artificial intelligence model includes a first layer and a second layer of the first artificial intelligence model, and
wherein the training of the second artificial intelligence model includes:
extracting feature vectors of the good quality images and feature vectors of the bad quality images through the first layer;
training the first layer such that a distance between the feature vectors of the good quality images and the feature vectors of the bad quality images is greater than or equal to a predetermined reference distance; and
training the second layer such that the feature vectors of the good quality images and the feature vectors of the bad quality images are sorted.

11. An artificial intelligence system trained by a server for inspecting a device, the server comprising:
a storage medium configured to store a first artificial intelligence model; and
a processor configured to train the first artificial intelligence model using good quality images of one or more display panels, generate a second artificial intelligence model including at least a partial layer of the first artificial intelligence model, and train the second artificial intelligence model using bad quality images of the one or more display panels, different than the good quality images,
wherein at least one of the bad quality images is a synthetic image in which a target portion is combined with a base image.

12. The server of claim 11, wherein the good quality images are sorted into a plurality of classes, and
wherein the processor:
extracts feature vectors of the good quality images through the first artificial intelligence model; and
trains the first artificial intelligence model such that the classes of the good quality images are sorted by the first artificial intelligence model based on the feature vectors of the good quality images.

13. The server of claim 12, wherein the processor:
predicts the classes of the good quality images, based on the feature vectors of the good quality images through the first artificial intelligence model;
calculates a loss, based on prediction values of the classes; and
trains the first artificial intelligence model to learn such that the loss satisfies a loss threshold value.

14. The server of claim 13, wherein the second artificial intelligence model includes a first layer and a second layer, and
wherein the processor:
extracts the feature vectors of the good quality images and feature vectors of the bad quality images through the first layer;
trains the first layer such that a distance between the feature vectors of the good quality images and the feature vectors of the bad quality images is greater than or equal to a predetermined reference distance; and
trains the second layer such that the feature vectors of the good quality images and the feature vectors of the bad quality images are sorted.

15. The server of claim 12, wherein the classes correspond to positions in the display panel,
wherein at least one of the bad quality images is a synthetic image in which a target portion is combined with a base image, and
wherein the base image is selected from the good quality images or is another good quality image.

16. The server of claim 11, wherein the good quality images are sorted into a plurality classes, and
wherein the processor:
extracts feature vectors of the good quality images through the first artificial intelligence model;
generates a probability distribution of each of the classes by inputting the feature vectors of the good quality images to a Gaussian Mixture Model (GMM);
calculates a loss, based on the probability distribution of each of the classes; and
trains the first artificial intelligence model such that the loss satisfies a loss threshold value.

17. The server of claim 11, wherein the second artificial intelligence model includes a first layer and a second layer of the first artificial intelligence model, and
wherein the processor:
extracts feature vectors of the good quality images and feature vectors of the bad quality images through the first layer;
trains the first layer to learn such that a distance between the feature vectors of the good quality images and the feature vectors of the bad quality images is greater than or equal to a predetermined reference distance; and
trains the second layer to learn such that the feature vectors of the good quality images and the feature vectors of the bad quality images are sorted.

18. A learning method of an artificial intelligence system for inspecting a device, the learning method comprising:
receiving first data including good quality images of one or more display panels;
preparing second data by marking the good quality image to generate bad quality images of the one or more display panels;
training a first artificial intelligence model using good quality images of one or more display panels; and
training a second artificial intelligence model including at least a partial layer of the first artificial intelligence model using bad quality images of the one or more display panels, different than the good quality images.

19. The learning method of claim 18, wherein the good quality images are sorted into a plurality of classes, and
wherein the training of the first artificial intelligence model includes:
extracting feature vectors of the good quality images through the first artificial intelligence model; and
training the first artificial intelligence model such that the classes of the good quality images are sorted by the first artificial intelligence model based on the feature vectors of the good quality images.

20. The learning method of claim 18, wherein the second artificial intelligence model includes a first layer and a second layer of the first artificial intelligence model, and
wherein the training of the second artificial intelligence model includes:
extracting feature vectors of the good quality images and feature vectors of the bad quality images through the first layer;
training the first layer such that a distance between the feature vectors of the good quality images and the feature vectors of the bad quality images is greater than or equal to a predetermined reference distance; and
training the second layer such that the feature vectors of the good quality images and the feature vectors of the bad quality images are sorted.
